(19) United States
(12) Patent Application Publication
(10) Pub. No.: US 2008/0114960 A1
(43) Pub. Date: May 15, 2008

(54) MEMORY CONTROL METHODS FOR ACCESSING A MEMORY WITH PARTIAL OR FULL SERIAL TRANSMISSION, AND RELATED APPARATUS

(76) Inventors: Tau-Li Huang, Hsinchu City (TW); Chin-Sung Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/559,879

(22) Filed: Nov. 14, 2006

(51) Int. Cl. G06F 12/00

(52) U.S. Cl. 711/167; 711/E12.001

(57) ABSTRACT

A memory control method for accessing a memory with partial or full serial transmission, includes: comparing a predicted data-to-command delay of a first data at a first address with a predicted time interval required for waiting for the first data's appearance in serially transmitted data from the memory; and if the predicted time interval is greater than the predicted data-to-command delay, sending a command to the memory to request the first data at the first address.

### BACKGROUND

The present invention relates to serial peripheral interface (SPI) control, and more particularly, to memory control methods for accessing a memory with partial or full serial transmission, and related apparatus.

As semiconductor technology progresses, decreasing pin counts of integrated circuits (ICs) for saving costs becomes an important issue. A solution for decreasing pin counts is to utilize a serial peripheral interface (SPI) related device such as a serial flash memory. According to SPI protocols, each new command introduces an initialization process comprising sending the new command and related addresses, so requested data in a memory such as a serial flash memory can be outputted for further utilization. If addresses of requested data correspond to high continuity, a ratio of the time required for initialization processes to the time required for data transmission is low. Conversely, if addresses of requested data correspond to low continuity, a ratio of the time required for initialization processes to the time required for data transmission is high, causing lower data accessing performance.

### SUMMARY

It is an objective of the claimed invention to provide memory control methods for accessing a memory with partial or full serial transmission, and related apparatus.

An exemplary embodiment of a memory control method for accessing a memory with partial or full serial transmission comprises: comparing a predicted data-to-command delay of a first data at a first address with a predicted time interval required for waiting for the first data's appearance in serially transmitted data from the memory; and if the predicted time interval is greater than the predicted data-to-command delay, sending a command to the memory to request the first data at the first address.

An exemplary embodiment of an apparatus capable of accessing a memory with partial or full serial transmission comprises: a processing circuit capable of requesting data in the memory; and a memory controller, coupled to the processing circuit and the memory, for accessing the memory for the processing circuit, wherein the memory controller is capable of comparing a predicted data-to-command delay of a first data at a first address with a predicted time interval required for waiting for the first data's appearance in serially transmitted data from the memory to the memory controller, and if the predicted time interval is greater than the predicted data-to-command delay, the memory controller sends a command to the memory to request the first data at the first address.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus capable of accessing a memory with partial or full serial transmission according to an embodiment of the present invention.

FIG. 2 is a timing chart of related signals shown in FIG. 1.

FIG. 3 is a flowchart of a memory control method for accessing a memory with partial or full serial transmission according to an embodiment of the present invention.

FIG. 4 is a flowchart of a memory control method for accessing a memory with partial or full serial transmission according to another embodiment of the present invention.

FIG. 5 is a flowchart of a memory control method for accessing a memory with partial or full serial transmission according to another embodiment of the present invention.

FIG. 6 is a timing chart of related signals in the embodiment shown in FIG. 5, where no initialization overhead is introduced in the situation that the criterion “N<M<(N+5)” shown in FIG. 5 is reached.

FIG. 7 is a timing chart of related signals according to the related art in contrast to the timing chart shown in FIG. 6, where an initialization overhead is introduced in a corresponding situation.

FIG. 8 is a diagram of an apparatus capable of accessing a memory with partial or full serial transmission according to another embodiment of the present invention.

### DETAILED DESCRIPTION

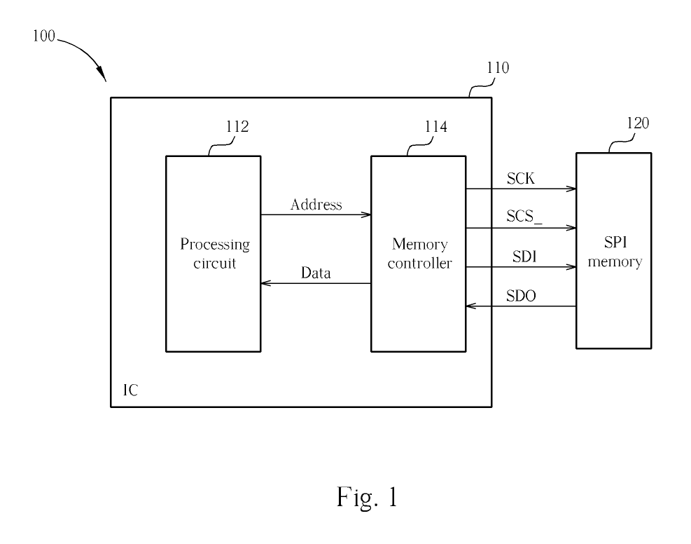

Please refer to FIG. 1. FIG. 1 is a diagram of an apparatus 100 capable of accessing a memory with partial or full serial transmission according to an embodiment of the present invention. According to some embodiments of the present invention, the memory mentioned above may partially or fully comply with serial peripheral interface (SPI) standards, while the implementation of these embodiments are not hindered. In the embodiment shown in FIG. 1, the memory is an SPI memory 120 complying with the SPI standards. As shown in FIG. 1, the apparatus 100 of this embodiment comprises an integrated circuit (IC) 110 and the SPI memory 120 mentioned above, and the IC 110 further comprises a processing circuit 112 and a memory controller 114. According to this embodiment, the memory controller 114 comprises a cash memory (not shown) for temporarily storing data.

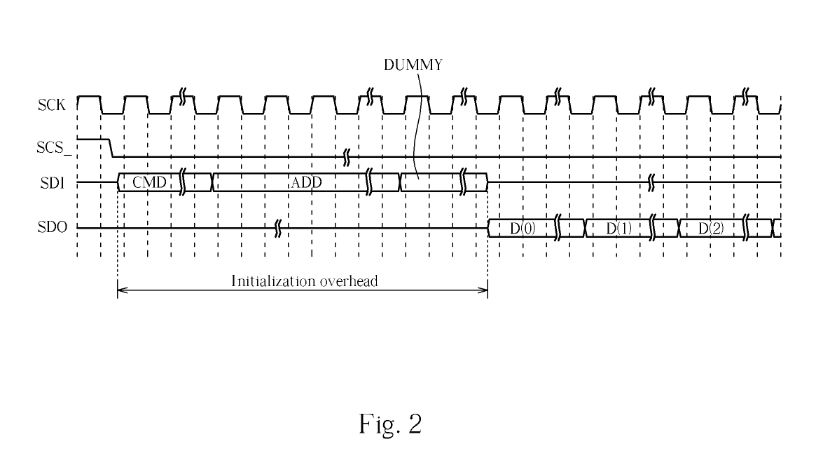

The memory controller 114 operates according to a memory control method for accessing a memory (e.g. the SPI memory 120) with partial or full serial transmission as disclosed in the present invention. In a certain situation, an initialization overhead latency, which can simply be referred to as the initialization overhead, is introduced while the memory controller 114 is accessing data such as data D(1), D(2), D(3), . . . , etc. carried by the SDO signal as shown in FIG. 2, where the SDI signal carries the corresponding command CMD and addresses ADD and even some dummy bits DUMMY, causing the initialization overhead mentioned above. In another situation, however, no initialization overhead is introduced since any unnecessary new command is strictly prohibited according to some criteria of this embodiment, in order to save the overall data accessing time.

Please note that the initialization overhead as shown in FIG. 2 can be considered to be a data-to-command delay, which represents a time interval between a first time point when the command CMD begins and a second time point when the first corresponding data D(0) appears.

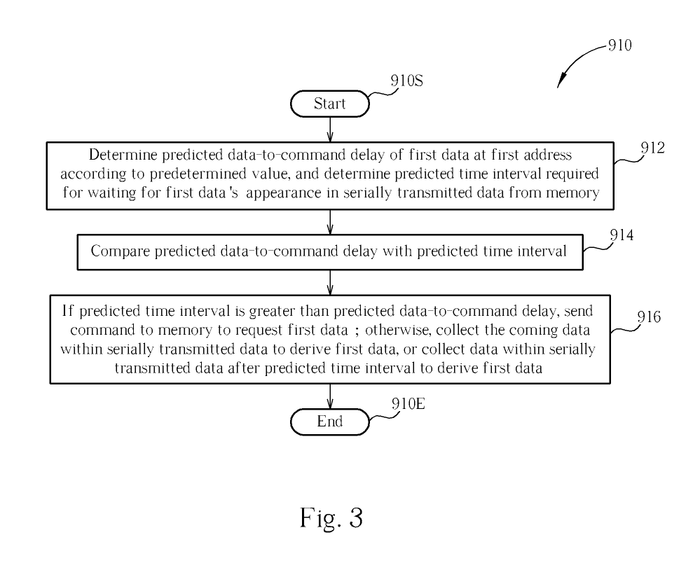

FIG. 3 illustrates a flowchart of a memory control method 910 according to an embodiment of the present invention, where the memory control method 910 can be applied to the embodiment shown in FIG. 1. The memory control method 910 is described as follows.

Step 910S: Start.

Step 912: Determine a predicted data-to-command delay of a first data at a first address according to a predetermined value, and determine a predicted time interval required for waiting for the first data's appearance in serially transmitted data from the memory such as the SPI memory 120, where the serially transmitted data in this embodiment is carried by the SDO signal. The predetermined value in Step 912 can be determined in advance according to trial experiments and/or theoretical calculations, so as to predict the data-to-command delay of the first data. Here, a portion of data within the serially transmitted data is currently transmitted from the SPI memory 120, and the address of the portion of data can be referred to as the current address. The predicted time interval can be determined according to the first address and the current address. For example, the predicted time interval corresponds to a difference between the first address and the current address.

914: Compare the predicted data-to-command delay with the predicted time interval.

Step 916: If the predicted time interval is greater than the predicted data-to-command delay, send a command to the SPI memory 120 to request the first data; otherwise, collect the coming data within the serially transmitted data to derive the first data, or collect data within the serially transmitted data after the predicted time interval (e.g. at the second time point mentioned above) to derive the first data.

Step 910 E: End.

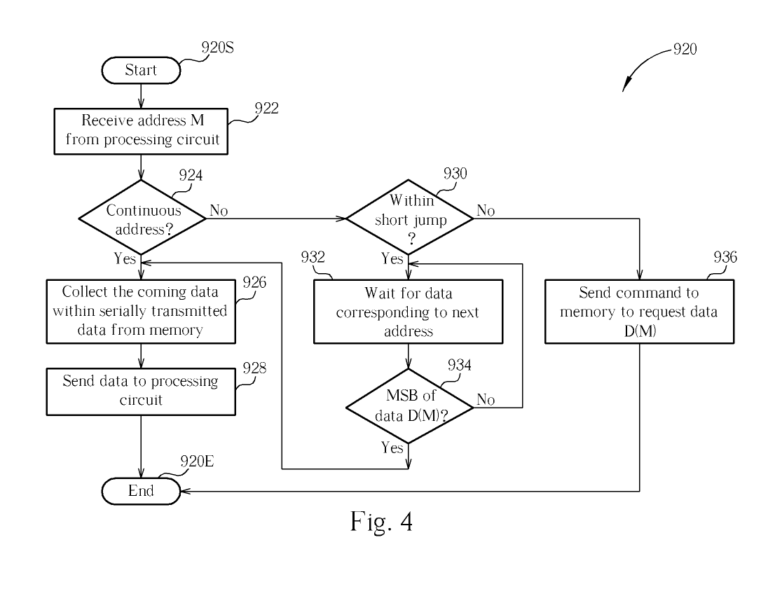

FIG. 4 is a flowchart of a memory control method 920 for accessing a memory with partial or full serial transmission according to another embodiment of the present invention, where this embodiment is a variation of the embodiment shown in FIG. 3, and the memory control method 920 can be applied to the embodiment shown in FIG. 1. In contrast to the memory control method 910, the memory control method 920 illustrates more implementation details as described in the following.

In Step 922, the memory controller 114 receives an address M from the processing circuit 112, where the processing circuit 112 is capable of determining the address M to request data D(M) at the address M. Here, an address N represents the current address mentioned above, and the address M represents the first address mentioned above.

In Step 924, the memory controller 114 checks whether the address M received is a continuous address with respect to the address N. More particularly, the memory controller 114 checks whether the address M is the next address of the address N. If the address M is the next address of the address N, enter Step 926; otherwise, enter Step 930.

In Step 926, the memory controller 114 collects the coming data within the serially transmitted data from SPI memory 120. As the address M is the next address of the address N, and as the serially transmitted data is carried by the SDO signal as mentioned above, the memory controller 114 may derive the data D(M) at the address M immediately after deriving the data D(N) at the address N.

In Step 928, the memory controller 114 sends data to the processing circuit 112. If the data requested by the processing circuit 112 is a series of continuous data starting from the address M, the memory controller 114 sends the requested data starting from the data D(M). If the data requested by the processing circuit 112 is simply the data D(M), the memory controller 114 sends the data D(M). After executing Step 928, enter Step 920E.

In Step 930, the memory controller 114 checks whether the address M is within a short jump in contrast to the address N. The criterion for determining this can be implemented by the comparison between the predicted data-to-command delay and the predicted time interval as mentioned in Step 914 in the embodiment shown in FIG. 3. If the address M is within a short jump in contrast to the address N, enter Step 932; otherwise, enter Step 936.

In a loop comprising Step 932 and Step 934, the memory controller 114 waits until the time point when the most significant bit (MSB) of the data D(M) appears. At the time point when the MSB of the data D(M) appears, Step 926 is re-entered, so the memory controller 114 starts collecting data to derive the data D(M).

In Step 936, the memory controller 114 sends a command to the SPI memory 120 to request the data D(M). After executing Step 936, enter Step 920E.

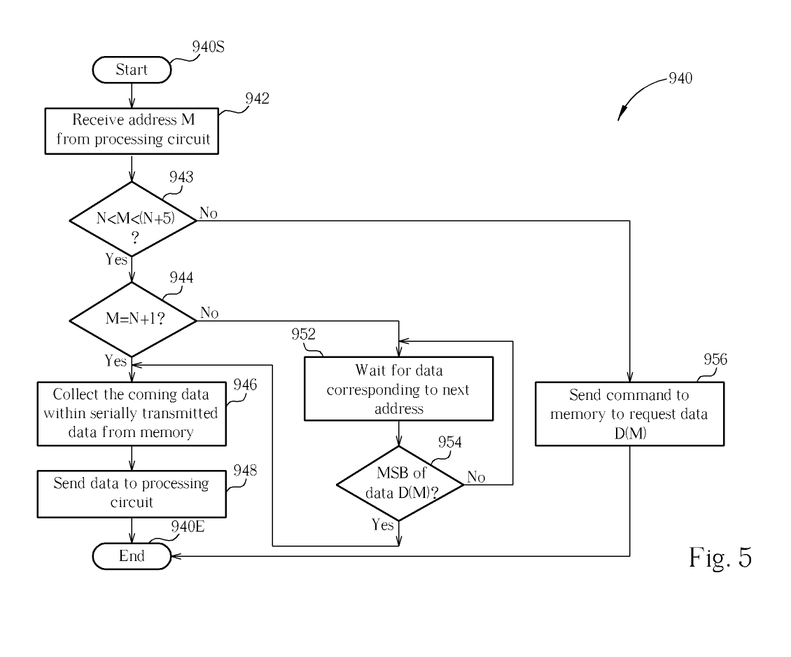

FIG. 5 is a flowchart of a memory control method 940 for accessing a memory with partial or full serial transmission according to another embodiment of the present invention, where this embodiment is a variation of the embodiment shown in FIG. 3 and also a variation of the embodiment shown in FIG. 4, and the memory control method 940 can also be applied to the embodiment shown in FIG. 1. The differences between the memory control method 920 and the memory control method 940 are described as follows. In the embodiment shown in FIG. 5, the addresses M and N represent byte-counts, so Step 944 is substantially implemented by checking whether the address M is the next address of the address N. In addition, Step 943 is substantially implemented by checking whether the address M is within a short jump defined by the criterion “N<M<(N+5)”, where “(N+5)” is derived from (N+1) plus 4, which corresponds to an average of data-to-command delays measured in unit of byte-counts. As a result, the embodiment shown in FIG. 5 has an altered check order in contrast to the embodiment shown in FIG. 4.

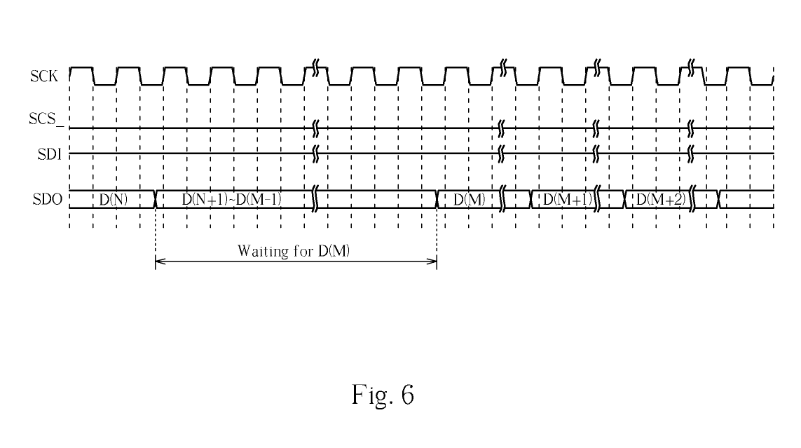

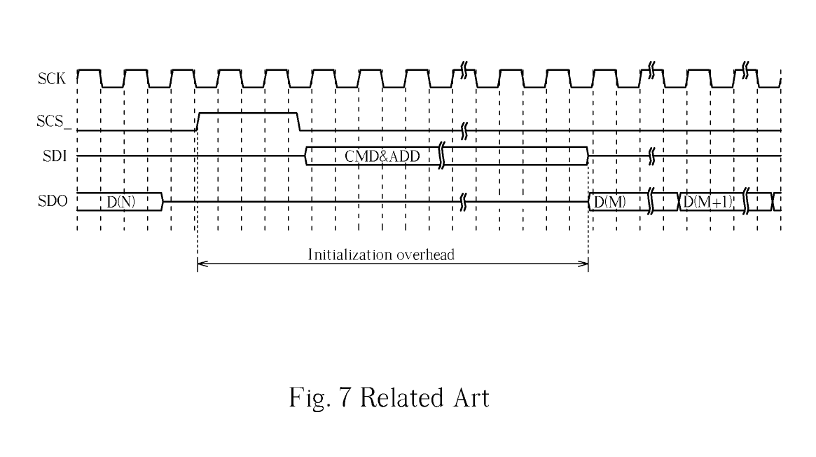

Please refer to FIG. 6 and FIG. 7. FIG. 6 is a timing chart of related signals in the embodiment shown in FIG. 5, where no initialization overhead is introduced in the situation that the criterion “N<M<(N+5)” shown in FIG. 5 is reached, and all the signals illustrated in FIG. 6 are all 1-bit signals. FIG. 7 is a timing chart of related signals according to the related art in contrast to the timing chart shown in FIG. 6, where an initialization overhead is introduced in a corresponding situation.

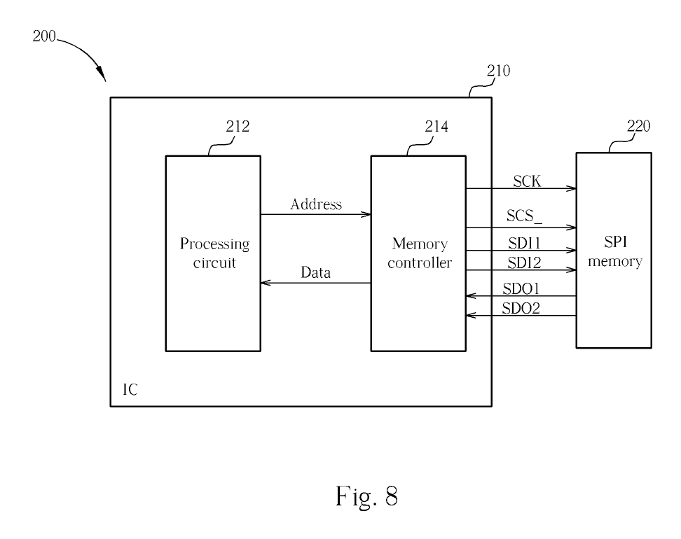

FIG. 8 is a diagram of an apparatus 200 capable of accessing a memory with partial or full serial transmission according to another embodiment of the present invention, where this embodiment is a variation of the embodiment shown in FIG. 1. Here, the memory in this embodiment can be an SPI memory 220 that partially complies with the SPI standards. The differences between the embodiment shown in FIG. 1 and embodiment shown in FIG. 8 are described as follows. The SDI signal shown in FIG. 1 is split into a first set of multiple bit signals SDI1 and SDI2, and the SDO signal shown in FIG. 1 is split into a second set of multiple bit signals SDO1 and SDO2, where the first set of multiple bit signals SDI1 and SDI2 are utilized for respectively carrying different bits of a byte originally carried by the SDI signal, and the second set of multiple bit signals SDO1 and SDO2 are utilized for respectively carrying different bits of a byte originally carried by the SDO signal.

According to the embodiment shown in FIG. 8, the memory controller 214 is capable of collecting data within the serially transmitted data carried by the set of SDO signals outputted from the SPI memory 220 (i.e. the second set of multiple bit signals SDO1 and SDO2 mentioned above). In addition, the memory controller 214 is capable of utilizing the set of SDI signals inputted into the SPI memory 220 (i.e. the first set of multiple bit signals SDI1 and SDI2 mentioned above) to carry the command and/or the first address.

According to a variation of the embodiment shown in FIG. 1 applied with the memory control method 910, the processing circuit 112 is capable of determining the first address to request the first data at the first address.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory control method for accessing a memory with partial or full serial transmission, comprising:
comparing a predicted data-to-command delay of a first data at a first address with a predicted time interval required for waiting for the first data's appearance in serially transmitted data from the memory; and
if the predicted time interval is greater than the predicted data-to-command delay, sending a command to the memory to request the first data at the first address.

2. The memory control method of claim 1, wherein the memory partially or fully complies with serial peripheral interface (SPI) standards.

3. The memory control method of claim 2, further comprising:
collecting data within the serially transmitted data carried by an SDO signal outputted from the memory.

4. The memory control method of claim 2, further comprising:
utilizing an SDI signal inputted into the memory to carry the command and/or the first address.

5. The memory control method of claim 2, wherein the memory partially complies with the SPI standards, and the memory control method further comprising:
collecting data within the serially transmitted data carried by a set of SDO signals outputted from the memory; or
utilizing a set of SDI signals inputted into the memory to carry the command and/or the first address.

6. The memory control method of claim 1, wherein a portion of data within the serially transmitted data is currently transmitted from the memory, a current address represents the address of the portion of data, and the memory control method further comprises:
if the predicted time interval is less than the predicted data-to-command delay and if the first address is the next address of the current address, collecting the coming data within the serially transmitted data to derive the first data.

7. The memory control method of claim 1, wherein a portion of data within the serially transmitted data is currently transmitted from the memory, a current address represents the address of the portion of data, and the memory control method further comprises:
if the predicted time interval is less than the predicted data-to-command delay and if the first address is not the next address of the current address, collecting data within the serially transmitted data after the predicted time interval to derive the first data.

8. The memory control method of claim 1, further comprising:
determining the predicted data-to-command delay according to a predetermined value.

9. The memory control method of claim 1, wherein a portion of data within the serially transmitted data is currently transmitted from the memory, a current address represents the address of the portion of data, and the memory control method further comprises:
determining the predicted time interval according to the first address and the current address.

10. The memory control method of claim 1, wherein the first address is determined by a processing circuit.

11. An apparatus capable of accessing a memory with partial or full serial transmission, comprising:
a processing circuit capable of requesting data in the memory; and
a memory controller, coupled to the processing circuit and the memory, for accessing the memory for the processing circuit, wherein the memory controller is capable of comparing a predicted data-to-command delay of a first data at a first address with a predicted time interval required for waiting for the first data's appearance in serially transmitted data from the memory to the memory controller, and if the predicted time interval is greater than the predicted data-to-command delay, the memory controller sends a command to the memory to request the first data at the first address.

12. The apparatus of claim 11, wherein the memory partially or fully complies with serial peripheral interface (SPI) standards.

13. The apparatus of claim 12, wherein the memory controller collects data within the serially transmitted data carried by an SDO signal outputted from the memory.

14. The apparatus of claim 12, wherein the memory controller utilizes an SDI signal inputted into the memory to carry the command and/or the first address.

15. The apparatus of claim 12, wherein the memory partially complies with the SPI standards, and the memory controller is capable of:
collecting data within the serially transmitted data carried by a set of SDO signals outputted from the memory; or
utilizing a set of SDI signals inputted into the memory to carry the command and/or the first address.

16. The apparatus of claim 11, wherein a portion of data within the serially transmitted data is currently transmitted from the memory, a current address represents the address of the portion of data, and if the predicted time interval is less than the predicted data-to-command delay and if the first address is the next address of the current address, the memory controller collects the coming data within the serially transmitted data to derive the first data.

17. The apparatus of claim 11, wherein a portion of data within the serially transmitted data is currently transmitted from the memory, a current address represents the address of the portion of data, and if the predicted time interval is less than the predicted data-to-command delay and if the first address is not the next address of the current address, the memory controller collects data within the serially transmitted data after the predicted time interval to derive the first data.

18. The apparatus of claim 11, wherein the memory controller determines the predicted data-to-command delay according to a predetermined value.

19. The apparatus of claim 11, wherein a portion of data within the serially transmitted data is currently transmitted from the memory, a current address represents the address of the portion of data, and the memory controller determines the predicted time interval according to the first address and the current address.

20. The apparatus of claim 11, wherein the processing circuit is capable of determining the first address to request the first data at the first address.
